(19) United States
(12) Patent Application Publication
(10) Pub. No.: US 2014/0149309 A1
(43) Pub. Date: May 29, 2014

(54) SYSTEM AND METHOD FOR VERIFYING REGISTERED MAIL RECEIPT

(71) Applicant: Electronics and Telecommunications Research Institute, Daejeon (KR)

(72) Inventors: Moon Sung PARK, Daejeon (KR); Hong Kyu PARK, Daejeon (KR)

(73) Assignee: Electronics and Telecommunications Research Institute, Daejeon (KR)

(21) Appl. No.: 13/952,154

(22) Filed: Jul. 26, 2013

(30) Foreign Application Priority Data
Nov. 26, 2012 (KR) 10-2012-0134645

(51) Int. Cl. G06Q 10/08

(52) U.S. Cl. CPC G06Q 10/0833
USPC 705/333

(57) ABSTRACT

A registered mail receipt verification system includes: a distribution integration information apparatus registering provisional receipt data for customer's receipt; a receipt information linking apparatus receiving the provisional receipt data from the distribution integration information apparatus and generating verification receipt data for at least one of an address and a postal code; and a registered mail verification apparatus registering the verification receipt data generated by the receipt information linking apparatus, reading a registered barcode for provided registered mail, and generating a verification result by comparison with the registered verification receipt data.

### CROSS-REFERENCE TO RELATED APPLICATIONS

This application claims priority to and the benefit of Korean Patent Application No. 10-2012-0134645 filed in the Korean Intellectual Property Office on Nov. 26, 2012, the entire contents of which are incorporated herein by reference.

### TECHNICAL FIELD

The present invention relates to a system and a method for verifying registered mail receipt, and more particularly, to a registered mail receipt verification system and a method thereof that examine nonreading of a barcode, misattachment of a registered barcode label, miswriting of receipt data, missorting a presorted receipt mail, nonsubmission, oversubmission, or the like at the time of receiving a registered mail in order to support enhancement of delivery quality for the registered mail provided as a high value mail service.

### BACKGROUND ART

Delivery quality which is service quality is very important in writing mail such as registered mail. However, in a delivery task of the registered mail, a lot of failure components exist, such as barcode nonreading, misattachment of a registered barcode label, miswriting of receipt data, missorting for presorted receipt mail, nonsubmission or excessive submission of the registered mail, and the like at the time of receipt of the registered mail.

For example, when a customer preliminarily registers a large quantity of mail receipt through an Internet post office apparatus, customer's mail is preliminarily registered through a large-quantity mail linking system, a registration number is granted based on receipt data which is requested to be registered and the customer uses the registration number at the time of producing the mail based on a receipt data file granted with the registration number. In this case, the customer produces the mail including sending address data and the granted registration number and thereafter, performs a receipt request. When the receipt request occurs, a receipt system performs a receipt procedure by a procedure of a progress of calculation and settlement of a postal charge through \textcircled{1} ascertaining a mail quantity (measuring a weight and ascertaining the quantity), \textcircled{2} ascertaining whether the receipt data is submitted, \textcircled{3} ascertaining whether the registered barcode is preliminarily printed and the registered barcode label provided in a receipt desk is attached by taking the registered mail which is requested to be received, and \textcircled{4} ascertaining the number of presorted bundles and the quantity when the mail is presorted and received because the receipt quantity is large.

However, in performing the procedure through the receipt processing progress, a calculated total weight value and an actual total weight measurement result value are compared based on sample registered mail during ascertaining the quantity for simplification of a receipt process and when a difference therebetween is in an error recognition range, a process of ascertaining whether a provisional receipt data quantity and an actual receipt quantity coincide with each other is omitted, and as a result, a difference in actual quantity of respective mail may occur.

In this case, the receipt data exists, but a nonsubmitted quantity which is not actually received may be generated and in this case, receipt data including the nonsubmitted quantity is transferred to a distribution center, a delivery office, and the like and maintained to cause a registration number use cycle to be shortened. When a charge calculated based on the receipt quantity is paid in the case where the excessive submission quantity is generated, sales are reduced and the receipt data does not exist, and as a result, a manual sending and arrival sorting operation is performed and inputting addressee information for delivery completion processing is requested, and as a result, an unnecessary operation is increased. If a customer who is, in advance, assigned with and uses the registration number first performs a mail production operation and does not submit the receipt data, only a submission scheduled date is ascertained and thereafter, receipt processing is performed, and as a result, when a sorting operation for each destination is performed through an automatic sorting facility in the distribution office, it is sorted that there is no receipt information and manual sorting is performed and the nonsubmission and the excessive submission quantity are not easily ascertained because whether the receipt quantity and the receipt data coincide with each other is not examined.

Since registered barcode printing quality cannot be examined with respect to all registered mail during a receipt procedure, a simple checking method is used in most cases. In this case, in a case where after receipt completion, a registered barcode for automatic sorting processing is not read through the automatic sorting facility and manually sorted and a case where the registered barcode is not read during generating delivery information as transfer and take-over information among distribution strongpoints, a method of collecting mail of which the registered barcode is not read and directly inputting the registered barcode in a delivery information generation system through a manual operation is performed and during this process, misinput may occur. After the manual sorting, the registered barcode is not read during generating the sending information (dispatch and arrival transfer and take-over information) and the registration number is thus manually input and misinput may occur due to an operator's mistake during the input process.

During the automatic sorting, even though the registered barcode is read, a sorting operation is performed by using a postal code corresponding to the read registration number. However, since whether the postal code is a correct postal code and whether a correct address is used are not examined based on an address included in receipt data during receipt, mail is sorted by a postal code miswritten in the receipt data and sent, and when the miswritten postal code is discovered during ascertaining whether the mail is missorted or communication, the miswritten postal code is corrected to normally deliver the mail to be communicated, but resulting communication quality deteriorates and a civil complaint occurs due to receipt customer's dissatisfaction.

A large quantity of registered mail is frequently presorted and received and when the mail is incorrectly presorted and received due to a mailing address data error or miswritten postal code in the presorted mail or the mail is included in mail of other regions due to an operator's mistake during a bundling operation by the unit of the presorted mail, the delivery quality deteriorates.

When the registered mail is received in a small quantity, misattachment may occur when attaching the registered barcode label provided by the customer and submitting the mail to the receipt desk or printing the registered barcode granted by the receipt data submitted through the Internet post office apparatus or manually labeling the mail with an Internet post issuing statement and in this case, the misattachment causes missorting during the sending and arrival sorting operation using the automatic sorting facility after receipt.

Accordingly, not a verification method for the postal charge but a preliminary examination method is requested with respect to mail to be received in order to minimize an additional task which occurs while performing tasks such as generation of sorting and whereabouts tacking information, a delivery, and the like during communication for the delivery after receiving the mail and a method for rereceiving rejected registered mail by examining whether the mailing address and the postal code are miswritten by the unit of individual mail is also required. A method for examining production quality of the mail is requested so as to prevent whether the mailing address and the postal code are miswritten from serving as the failure occurrence cause in mail communication by not examining the mail by the unit of a bundle or a tray but examining the mail by the unit of individual mail even in the case where the mail is presorted and received. A method for minimizing a receipt data error afterwards by providing receipt data corrected by the customer while using a verification result and a corrected receipt data statement during a sending and arrival sorting operation is requested.

### SUMMARY OF THE INVENTION

The present invention has been made in an effort to provide a registered mail receipt verification system and a method thereof that verify receipt data for a preregistered mail during receiving a registered mail, examine a registered barcode printing state, missorting or not (miswriting of a mailing address and a postal code), nonsubmission, and whether there is an exceeded submitted quantity, and provide a re-receipt or re-verification method in accordance with an examination result, generate and provide data for modifying a mail for each examination result and reach each rejection d type and re-receiving the modified mail, provide miswritten statements of the mailing address and the postal code to a receipt customer, generate and provide a correct postal code when the mailing address is normal in receipt data, generate and provide statistics information regarding a verification result statement to provide information on a registered mail receipt quality enhancement state of the customer.

An exemplary embodiment of the present invention provides a registered mail receipt verification system including: a distribution integration information apparatus registering provisional receipt data for customer's receipt; a receipt information linking apparatus receiving the provisional receipt data from the distribution integration information apparatus and generating verification receipt data for at least one of an address and a postal code; and a registered mail verification apparatus registering the verification receipt data generated by the receipt information linking apparatus, reading a registered barcode for a provided registered mail, and generating a verification result by comparison with the registered verification receipt data.

The system may further include a receipt apparatus receiving registered mail of a predetermined quantity or less from the customer, and assigned with a registration number from the distribution integration information apparatus and providing the assigned registration number to the customer.

The system may further include an Internet post office apparatus receiving a receipt file for registered mail which exceeds the predetermined quantity from the customer through a network, registering a provisional receipt file corresponding to the received receipt file, and transmitting a registration number to the customer corresponding to the registered provisional receipt file.

The distribution integration information apparatus may receive the provisional receipt file from the Internet post office apparatus and register provisional receipt data, and transmit the registered provisional receipt data to the receipt information linking apparatus.

The receipt information linking apparatus may receive and register the verification result generated by the registered mail verification apparatus and transmit the registered verification result to the receipt apparatus.

When only modification of the postal code is required based on the verification result, the receipt apparatus may reprint a rejection statement so that the address and the postal code are included in the registered barcode label at the time of printing a rejection statement and provide the rejection statement to the customer or label rejected mail.

The registered mail verification apparatus may compare a presorted input and registered value, and the verification receipt data when a verification content of the registered mail is a presorted bundle and when the presorted input and registered value, and the verification receipt data do not coincide with each other, the registered mail verification apparatus may identify the registered mail as missorted mail.

The registered mail verification apparatus may generate delivery information which is transfer information for shipping the presorted mail to a next distribution point to register the generated delivery information in the distribution integration information apparatus when a verification result of the presorted mail is accepted.

Another exemplary embodiment of the present invention provides a registered mail receipt verification method executed by a registered mail receipt verification system including: registering, by a distribution integration information apparatus, provisional receipt data for customer's receipt; receiving, by a receipt information linking apparatus, the provisional receipt data and generating verification receipt data for at least one of an address and a postal code; and registering, by a registered mail verification apparatus, the verification receipt data generated by the receipt information linking apparatus, reading a registered barcode for provided registered mail, and generating a verification result by comparison with the registered verification receipt data.

The method may further include receiving, by a receipt apparatus, registered mail of a predetermined quantity or less from the customer, and being assigned with a registration number from the distribution integration information apparatus and providing the assigned registration number to the customer.

The method system may further include receiving, by an Internet post office apparatus, a receipt file for registered mail which exceeds the predetermined quantity from the customer through a network, registering a provisional receipt file corresponding to the received receipt file, and transmitting a registration number to the customer corresponding to the registered provisional receipt file.

The method may further include receiving, by the distribution integration information apparatus, the provisional receipt file from the Internet post office apparatus and registering provisional receipt data, and transmitting the registered provisional receipt data to the receipt information linking apparatus.

The method may further include receiving and registering, by the receipt information linking apparatus, the verification result generated by the registered mail verification apparatus and transmitting the registered verification result to the receipt apparatus.

The method may further include, when only modification of the postal code is required based on the verification result, reprinting, by the receipt apparatus, a rejection statement so that the address and the postal code are included in the registered barcode label at the time of printing a rejection statement and providing the rejection statement to the customer or labeling rejected mail.

Herein, the registered mail verification apparatus may compare a presorted input and registered value, and the verification receipt data when a verification content of the registered mail is a presorted bundle and when the presorted input and registered value, and the verification receipt data do not coincide with each other, the registered mail verification apparatus may identify the registered mail as missorted mail.

The registered mail verification apparatus may generate delivery information which is transfer information for shipping the presorted mail to a next distribution point to register the generated delivery information in the distribution integration information apparatus when a verification result of the presorted mail is accepted.

The registered mail verification apparatus may perform temporarily stopping the verification apparatus when presorted mail and missorted mail are continuously generated in a predetermined reference quantity or more during verifying the presorted mail; conveying the presorted and missorted mail which are temporarily stopped in the case of incorrectly provided presorted mail and mail of which a verification operation is not completed to a designated sorting space, and correcting verification statistics of missorted mail which is continuously generated; storing a registration number of the incorrectly provided presorted mail in a temporary buffer; and generating delivery information including a directly input result value by reading a presorting number or a registered barcode of the selected presorted or missorted mail.

According to exemplary embodiments of the present invention, after receipt of registered mailgeneration of an additional task by nonreading a barcode during a process of sorting dispatching and arrival, degradation of delivery service quality by misinputting and missorting of a registration number, generation of additional tasks by nonsubmission or oversubmission of a registered mail, or by generation of quantities of mail of which registration numbers overlap with each other or a cause of unnecessary data communication can be minimized.

According to the exemplary embodiments of the present invention, a customer mailing address data verification result and a mail submission quality examination result are provided to improve the quality of a received mail.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram schematically illustrating a registered mail receipt verification system according to an exemplary embodiment of the present invention.

FIG. 2 is a diagram illustrated to describe functions of respective components of the registered mail receipt verification system of FIG. 1,

FIG. 3 is a diagram illustrating an example of generation and management of verification reference data by a receipt information linking device.

FIG. 4 is a diagram illustrating an example of a generation statement of the verification reference data and management of a verification result by the receipt information linking device.

FIG. 5 is a diagram illustrating an example of verification result statistics management by the receipt information linking device.

FIG. 6 is a diagram illustrating an example of a main screen of a registered mail verification apparatus.

FIG. 7 is a diagram illustrating an example of a delivery information generation screen of the registered mail verification apparatus.

FIG. 8 is a flowchart illustrating a method for verifying receipt of a registered mail according to an exemplary embodiment of the present invention.

FIG. 9 is a flowchart illustrating a method for verifying receipt of a registered mail according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Hereinafter, a system and a method for verifying registered mail receipt according to exemplary embodiments of the present invention will be described in detail with reference to the accompanying drawings.

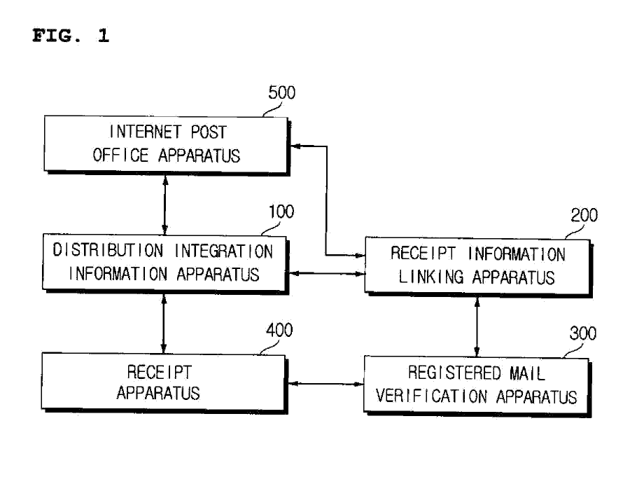

FIG. 1 is a diagram schematically illustrating a registered mail receipt verification system according to an exemplary embodiment of the present invention.

Referring to FIG. 1, a registered mail receipt verification system according to an exemplary embodiment of the present invention may include a distribution integration information apparatus 100, a receipt information linking apparatus 200, a registered mail verification apparatus 300, a receipt apparatus 400, and an Internet post office apparatus 500.

The distribution integration information apparatus 100 registers provisional receipt data for customer's receipt.

The receipt information linking apparatus 200 receives the provisional receipt data from the distribution integration information apparatus 100 and generates verification receipt data for at least one of an address and a postal code.

The registered mail verification apparatus 300 registers the verification receipt data generated by the receipt information linking apparatus 200, reads a registered barcode for a provided registered mail, and compares the read registered barcode with the registered verification receipt data to generate a verification result.

The receipt apparatus 400 receives registered mail of a predetermined quantity or less from a customer and is assigned with a registration number from the distribution integration information apparatus 100 and provides the registration number to the customer.

The Internet post office apparatus 500 receives a receipt file for registered mail which exceeds the predetermined quantity from the customer through a network, registers a provisional receipt file corresponding to the received receipt file, and transmits a registration number to the customer corresponding to the registered provisional receipt file.

In this case, the distribution integration information apparatus 100 may register the provisional receipt data by receiving the provisional receipt file from the Internet post office apparatus 500, and may transmit the registered provisional receipt data to the receipt information linking apparatus 200.

The receipt information linking apparatus 200 may receive and register the verification result generated by the registered mail verification apparatus 300, and transmit the registered verification result to the receipt apparatus 400.

When only modification of the postal code is required based on the verification result, the receipt apparatus 400 reprints a rejection statement so that the address and the postal code are included in the registered barcode label at the time of printing the rejection statement to provide the rejection statement to the customer or label a rejection mail.

The registered mail verification apparatus 300 compares a presorted input and registered value, with the postal code of the verification receipt data when a verification content of the registered mail is a presorted bundle and when the presorted input and registered value, and the postal code of the verification receipt data do not coincide with each other, the registered mail may be identified as a missorted mail.

The registered mail verification apparatus 300 generates delivery information which is transfer information for shipping the presorted mail to a next distribution point to register the generated delivery information in the distribution integration information apparatus when a verification result of the presorted mail is accepted.

When the provisionally received receipt data is registered in the distribution information apparatus 100 in order for a large-quantity registered mail applying customer to be assigned with the registration number for applying the mail, the provisionally received receipt data is transmitted to the receipt information linking apparatus 200 of a receipt division.

When the registered mail verification apparatus 300 receives the provisional receipt data, the registered mail verification apparatus 300 identifies whether the postal code is miswritten in the receipt data of the customer by generating a correct postal code based on a basic address, with reference to the mailing address of the received data, and generates identification data indicating whether an address is miswritten when the postal code is not generated.

When preliminary examination of the mailing address and the postal code is completed, the registered mail verification apparatus generates verification reference data for verification by actual registered mail barcode reading to be registered in a DB for registering the verification reference data.

When receipt of the registered mail is requested, whether the provisional receipt data is submitted is identified through the receipt information linking apparatus 200, a verification condition for a registered mail to be received is registered in a receipt information linking system, preparation of a verification operation is performed through ascertaining and registering the verification condition, when the preparation of the verification operation is completed, the registered mail is provided to a verification apparatus and read by a registration barcode, and the registered mail is compared with the verification reference data which coincides with the registration number in the receipt data registered as the verification reference data to generate a verification result. The registered mail verification apparatus 300 first examines whether the registered mail is read by the registration barcode during the above process and examines whether the mailing address and the postal code are miswritten.

In this case, the registered mail verification apparatus 300 compares the presorted mail with a statement input during the verification operation or registered as preliminary verification reference data to perform a verification process including the missorted case.

The delivery information may be generated and registered by the unit of a presorted bundle when the registered mail which is presorted and received is accepted as the verification operation result, and as a result, the registered mail may be dispatched immediately without being transferred to a work field where a sorting task is performed.

In the case of the rejection as the verification result, a receipt data change statement for re-receipt or re-verification for each rejection type is included and provided. Since receipt mail quality management for each customer is enabled by providing statistics for each customer, each task time, and each sequence by the verification result, a method for the receipt customer to use base information for enhancing mail production and submission quality or use the verified mailing address data is provided to minimize an error of the receipt data.

The receipt information linking apparatus 200 may generate and provide the verification reference data by linking data provisionally received by the customer and data provisionally received through a receipt system, and manage the result verified by the registered mail verification apparatus, and generate and provide the receipt data statement rereceived and verified for each rejection type in the case of the rejected mail. When the registered mail is received by such a method, the mail may be missorted until the delivery after the receipt or operation cost during communication may be saved.

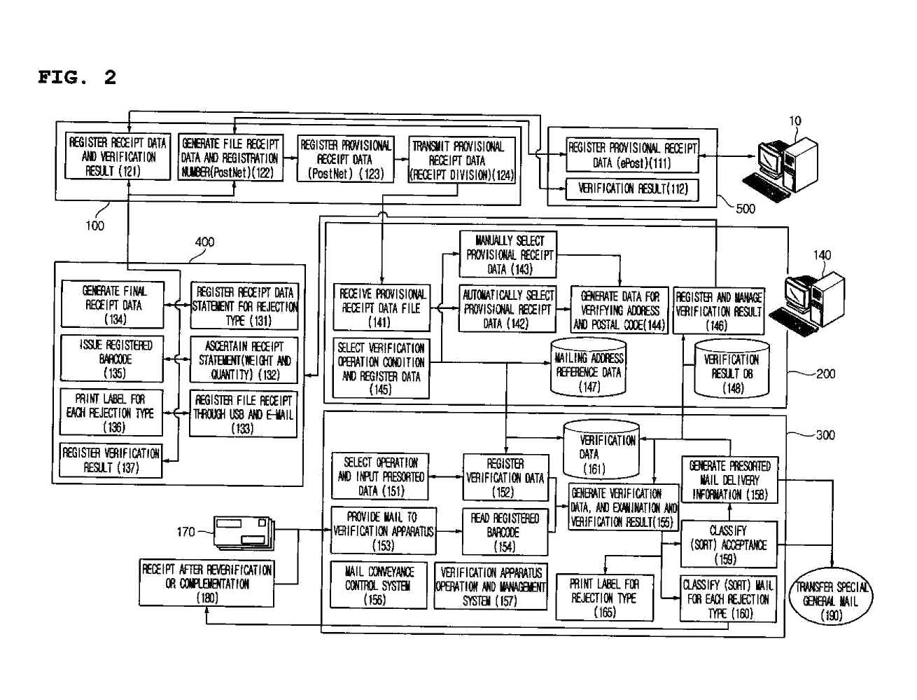

FIG. 2 is a diagram illustrated to describe functions of respective components of the registered mail receipt verification system of FIG. 1.

When the customer Provisionally receives the receipt data file through the Internet post office (alternatively, large-quantity mail receipt linking) apparatus 500, the provisional receipt data is registered in a provisional receipt DB of the distribution information apparatus 100 and the registered data is transmitted to the receipt division and the registered provisional receipt data is transmitted to the receipt information linking apparatus 200 to be registered at a designated location.

When the provisional receipt data is received, reception state is provided in a pattern of a list and the received provisional receipt data statement is provided with respect to a provisional receipt data registration completion data, a customer name, a quantity, a receipt scheduled data, and the like (141 and 142).

When the provisional receipt data is submitted directly to the person in charge of receipt as a format of an e-mail or a USB file (130), a receipt statement is ascertained based on a quantity measurement result by the receipt apparatus 400 (131), the receipt data submitted by the customer is read to generate registration numbers as large as the submitted quantity and data of which the registration number is completely generated is registered as the provisional receipt data (122 and 123).

When the generation of the registration number is completed, a registered barcode label is printed based on the generated registration number (135) and provided to a customer 10 and at this time, the customer attaches the registered barcode label (170) and submits the provisional receipt data attached with the registered barcode label.

When a provisional receipt data receiving list is generated through reference numeral 124 (141, 142, and 143), address data statements submitted are read in a receiving order to generate a correct postal code 144 by using a postal code DB and address word data on mailing address reference data 147 based on address data. In this case, by a result of comparing whether the postal code registered in the provisional receipt data and the generated postal code coincide with each other, in the case where the correct postal code is not generated due to a postal code discordance status value and address miswriting, address data required to be corrected depending on an address error statement is generated and an address miswriting status value is generated (144) by finding a miswriting location of the address data based on a result value of inquiring about the mailing address reference data with a postal code written by the customer.

A status value for a generation result of a quality examination data value for the postal code and address data by the provisional receipt data submitted by the customer is included and registered as registered mail verification receipt data (144 and 152).

When the file is received through the person in charge of receipt (143), the receipt quantity is small and the file is directly submitted. Therefore, a method is provided, which selects a verification reference data generation operation sequence 142 from the received provisional receipt data list to preferentially perform the selected verification reference data generation operation sequence 142 in order to minimize a customer verification operation standby time.

In the case where the quantity is ascertained and mail submission condition is ascertained while the receipt operation is performed, when reference data for verifying a customer name and an ID, a provisional receipt data submission status, whether a barcode is preliminarily printed, whether the mail is presorted, and the like is input in a receipt information linking system 145, the input data value is registered in the verification apparatus 300 as the verification reference data (152).

After registration of reference data for a receipt quantity (152 and 161) is completed, the verification apparatus 300 is driven through a menu of the verification apparatus 300 (153) and a verification receipt data registration status value and a verification reference data registration status value are provided to ascertain whether a mail to be verified and verification reference data of a corresponding customer are registered.

In general, the verification receipt data is generated immediately after provisional receipt is completed and thus provided as the list and verification customer reference data is registered just before the verification operation, and as a result, the verification customer reference data is provided as a value of a top layer (142 and 143) as a verification operation list provided to the verification apparatus simultaneously when the verification customer reference data is registered.

When a verification operation start operation is selected, a status in which mail supply 153 to an inlet of the verification apparatus is enabled is kept by driving the apparatus in order to provide a verification mail.

When a mail to be subjected to the verification operation is provided, the mail is conveyed sequentially to acquire mail images, all barcodes which are provided on the mail are extracted, and it is examined whether a duplicated registered barcode exists, and whether barcode symbology and a registration number digit number coincide to identify the registered barcode (155). When it is identified that the registered barcode does not exist, a barcode nonreading status value is registered as the verification result value (146), a reading result is generated with respect to the identified registered barcode (154), and when the read result coincides with a registration number allocation system (154), the verification receipt data is inquired by a registration number value (161). When an inquiry result exists, the fact that the mail is verified by a preliminary verification result value of the postal code and the mailing address is registered in the verification reference data as an examination value (155 and 148) and when the mail is received as the presorted mail, a presorting number value for the registered mail is input (selected) in the verification apparatus (151). When it is identified that the mail with the corresponding registration number is already normally processed as an inquiry result, the mail is conveyed to a corresponding sorting hole as a registration number duplicated mail and rejection statistics data is generated.

When, the mail is identified by postal miswriting and mailing address miswriting which coincide with the registration number and it is identified that the values and numbers coincide with each other and registered, a registered postal code value is compared with a presorting number and it is identified whether the registered postal code value coincides with the presorting number and the identification result is registered (155 and 148) and the individual registered mail is verified and it is examined whether a sequence of the registration number and a providing sequence of the verification mail coincide with each other and when they do not coincide with each other, a registered barcode label misattachment status value is registered as a result value (155 and 148), and an examination result status value is provided to a mail flow controller. A mail conveyance controller conveys the mail to a location to coincide with a classification schedule value by a verification result status value and inserts the mail into sorting holes (159 and 160).

A method (151) of selecting the mail providing sequence so as to perform the verification operation by dividing a case in which the mail is not presorted and a case in which the mail is presorted and submitted is provided.

When it is ascertained that the verification is completed in the case where the verification operation for each customer is completed, completion of the verification operation is selected to inquire about a verification result status value defined in a field of verification receipt data for each customer to generate rejection and acceptance type lists (155) and register the lists as a result (148).

The rejection type list including a correct postal code value or corrected address data is generated from a status value generated for each rejection type and thus registered as data for managing the result of the receipt information linking system (146 and 148).

The receipt apparatus 400 generates and provides a label 136 so as to update receipt data for each cause and attach the updated data to the rejected mail by inquiring about data generated for each rejection type for the verification result data.

A receipt processing and reverification operation selecting method (145) to reverify or receive a mail attached with a label (including the registered barcode) reissued through the process is provided. When reverification is selected, the verification operation is restarted and when the mail is accepted in reverification, the verification result value is registered as secondary verification result data (146 and 148).

When the receipt processing is completed, customer's data of which verification is completed is deleted from the verification receipt data used in the verification (146 and 161).

An inquiry method (112) is provided so as to provide verification results for each customer and for each period to an operator and the customer through registration (137 and 121) of result data of which verification is completed.

As a status of the verification operation result, statements of verification results for each customer and each date of a verification operation point, and changed receipt data are provided (137 and 112).

As the verification result statement, whether addresses of all addressees are miswritten, whether the basic address is miswritten, whether the postal code is miswritten, the correct postal code, whether the registered barcode is read, whether the registration number is reduplicatively used, whether the mail is not submitted, whether a registration number which is not approved is used, whether the mail is missorted among the presorted mail, whether the registered barcode label is misattached, and the result are generated (155) based on provisional receipt data and registered as the verification result (146 and 137).

The provisional receipt data are arranged in the order of the postal code and thereafter, the reference address data for the postal codes sequentially submitted by the customer are sequentially compared to examine whether the address data is miswritten (144). As the correct postal code generating method, the same method is adopted to generate the correct postal code more rapidly (144).

The registered mail receipt verification system according to the exemplary embodiment of the present invention includes a verification apparatus operation and management system that provides a method (157) of providing a barcode reading rate, a verification acceptance status, and a processing quantity value for each rejection cause based on the examination result and the sorting result to the sorting hole so as to monitor the verification processing progress result while the mail is provided to the verification apparatus 300.

The registered mail receipt verification system includes a method (165) of printing and attaching the registered barcode label and the address label in the case of the miswriting of the registered barcode and the postal code among the rejection types.

The registered mail receipt verification system includes a conveyance control system 156 that provides a method of controlling a status such as jam and double feeding while the mail is provided and conveyed.

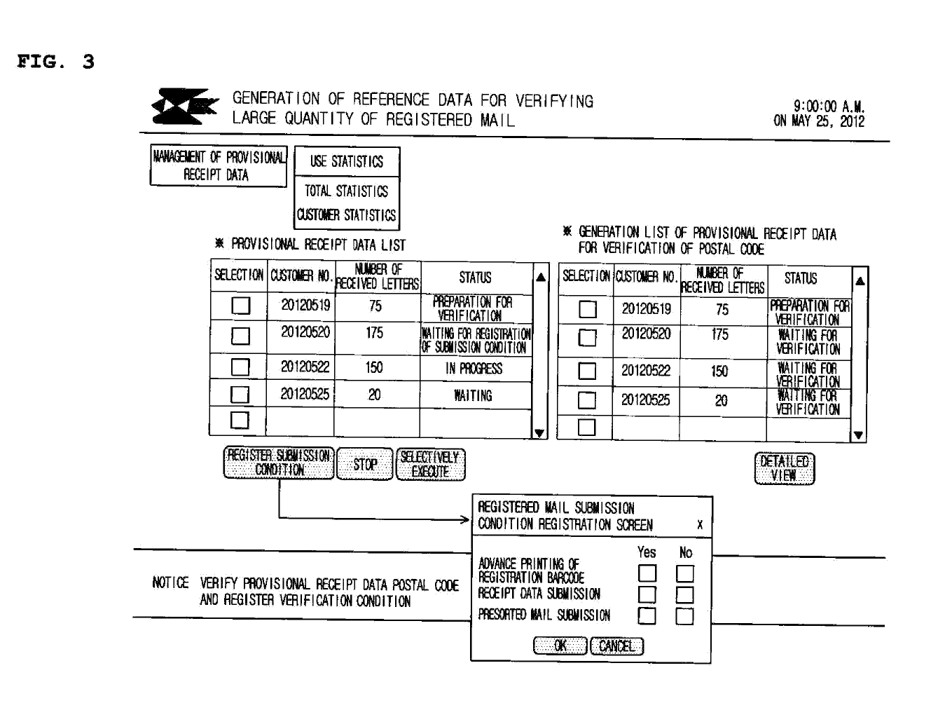

FIG. 3 is a diagram illustrating an example of generation and management of verification reference data by a receipt information linking apparatus.

The receipt information linking apparatus 200 may provide a provisional receipt data receiving statement during a process of generating the verification receipt data and provide a method of selecting the generation operation sequence of the verification receipt data As a providing content regarding a generation status of the verification receipt data, an address data/postal code preverification result generation statement is provided. The receipt information linking apparatus 200 may provide a method for registering a verification condition while receiving the mail of the customer and provide a verification progress statement to be ascertained.

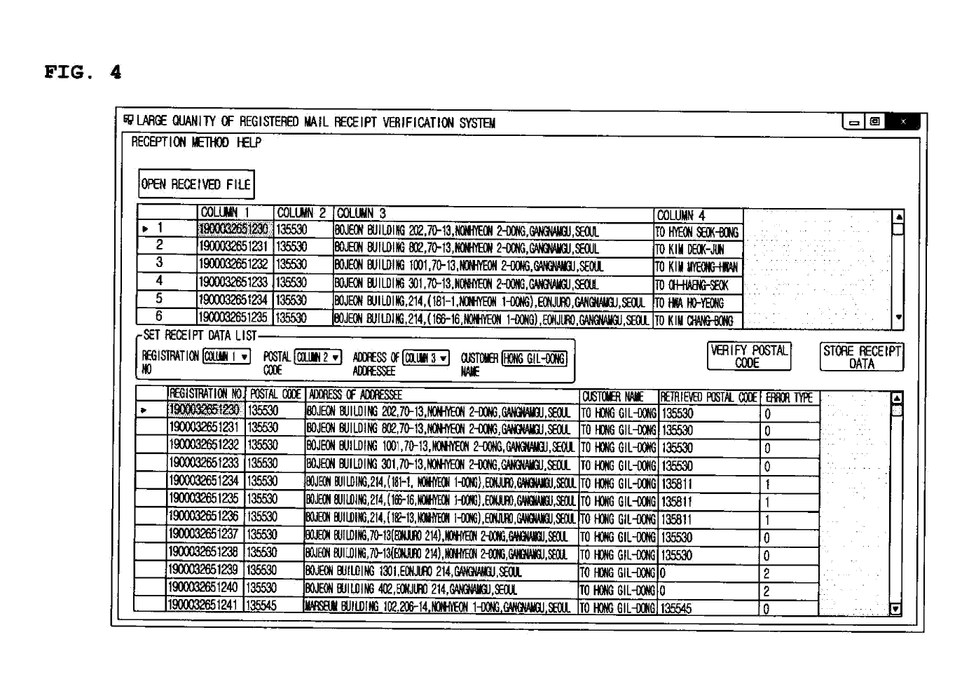

FIG. 4 is a diagram illustrating an example of management of a generation statement of the verification reference data and a verification result by the receipt information linking apparatus.

The receipt information linking apparatus 200 may ascertain a data statement transmitted to the verification apparatus 300 among contents provided in FIG. 3 and provide a mailing address and postal code verification result and a verification completion result and in this case, a detailed statement for the postal code verification result may be ascertained and when the verification is completed, the detailed statement may be provided for each rejection cause and the verification result may be automatically stored in the file.

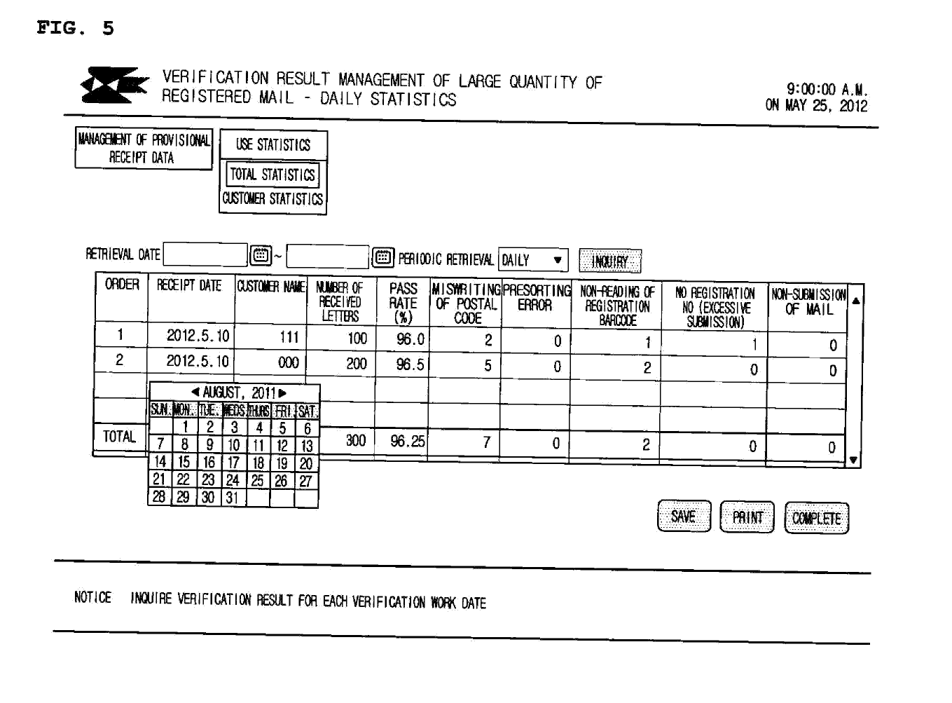

FIG. 5 is a diagram illustrating an example of verification result statistics management by the receipt information linking apparatus.

The receipt information linking apparatus 200 may inquire verification statistics for the verification result for each customer and for each period for each day/month/year). In this case, the receipt information linking apparatus 200 may provide the verification result by the unit of individual mail in the case of the statistics for each day.

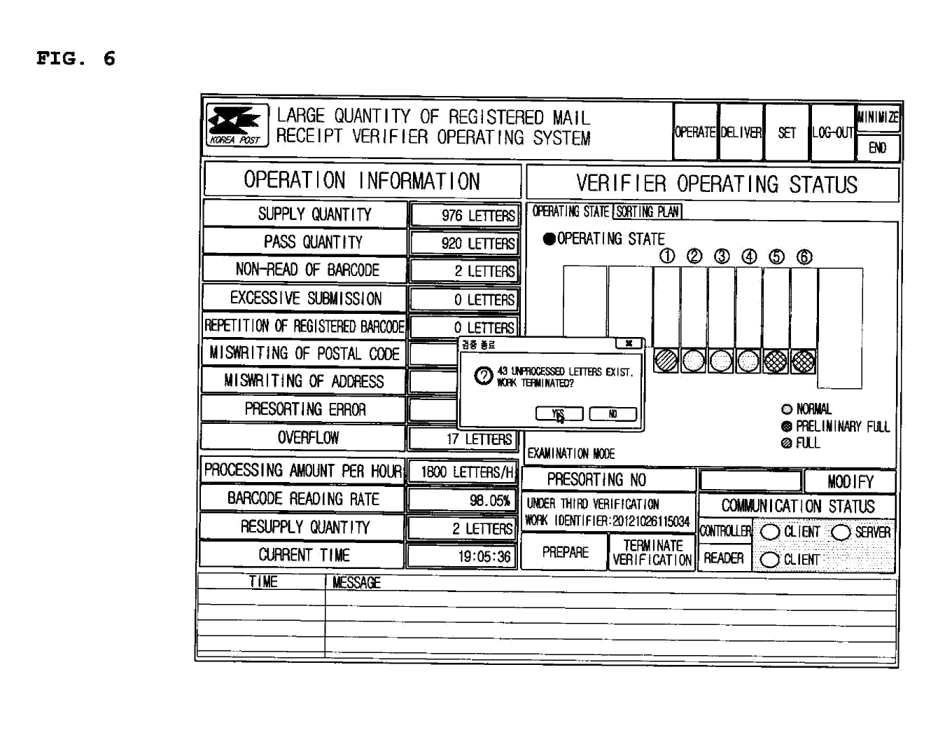

FIG. 6 is a diagram illustrating an example of a main screen of a registered mail verification apparatus.

The registered mail verification apparatus 300 provides a method of ascertaining information on a control of an operation status of receipt verification of a large quantity of registered mail, and operation preparation and apparatus status checking for the verification apparatus 300, and discovering an abnormal status and an operation status in status checking, and provides a pause method when the operation sequence needs to be changed. The registered mail verification apparatus 300 provides operation status information such as verification processing capability, barcode reading rate, or the like in real time.

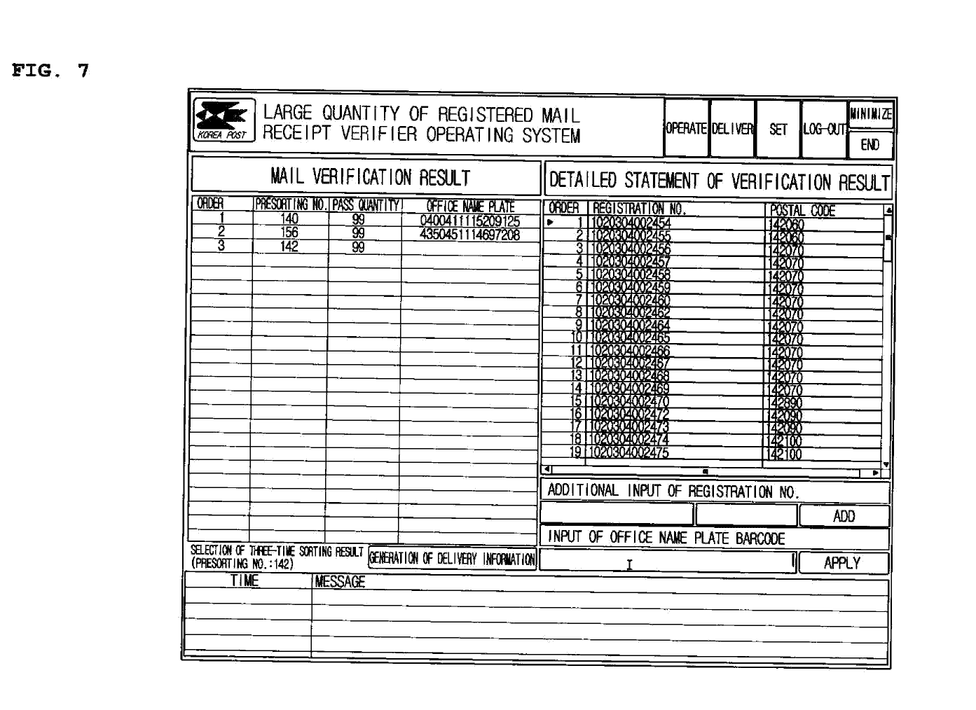

FIG. 7 is a diagram illustrating an example of a delivery information generation screen of the registered mail verification apparatus.

The registered mail verification apparatus 300 provides a delivery information generating method based on the verification completion result value by the presorting number among verification results of the large quantity of registered mail. The registered mail verification apparatus 300 provides a method of providing and changing a verification result list for each presorting number input result with respect to the presorting verification operation result. The registered mail verification apparatus 300 stores a delivery information generation statement as a file when selecting delivery information storing by reading an office name division name mark barcode in addition to the presorting result.

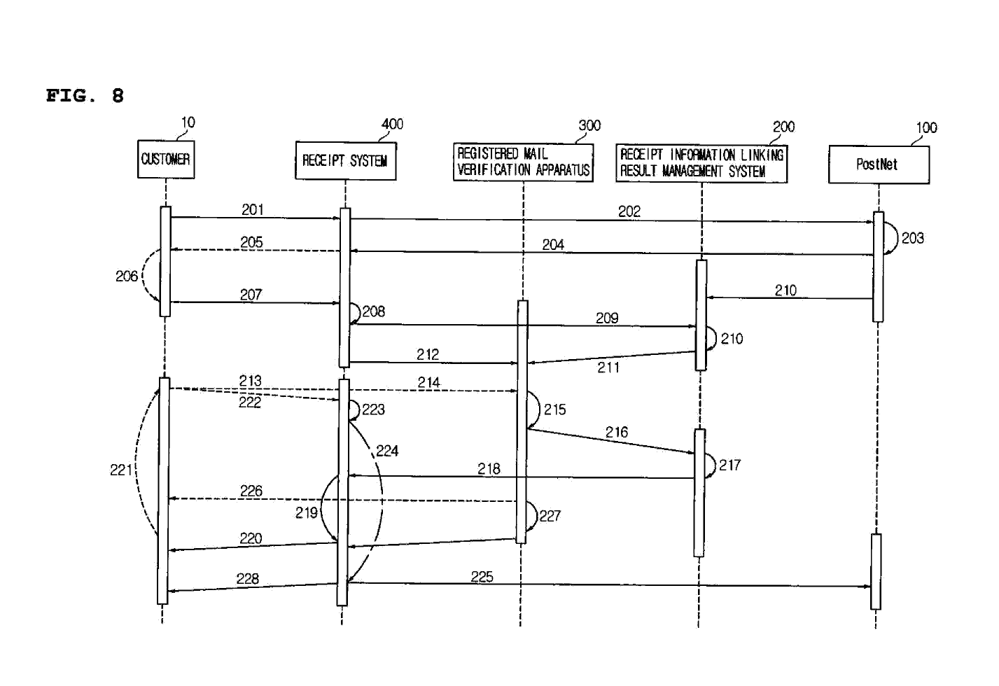

FIG. 8 is a flowchart illustrating a method for verifying receipt of a registered mail according to an exemplary embodiment of the present invention.

The customer 10 may preliminarily transmit a receipt data file to the person in charge of the receipt system through the e-mail (201) or directly submit the file at the time of applying the registered mail, when applying a small quantity of registered mail. The receipt apparatus of the receipt system requests a receipt quantity/a receipt data reference registration number (202). In this case, the receipt apparatus 400 is assigned with a registration number allocation range through the receipt system 400 (203) and provides the assigned registration number allocation range to the customer 10 (204 and 205). When the file is directly submitted, the registered barcode label is output (204 and 205) and provided through the receipt apparatus 400 by the generated registration number and when the e-mail is received, the registration number is notified to the customer (205).

Mail reflected with a registration number is produced (206), sample mail is submitted (207), and a weight/quantity is ascertained (208). When generation of the verification data is selected after the verification (209), the receipt information linking apparatus 200 generates the verification receipt data (210) and registers the verification receipt data in the registered mail verification apparatus 220 (211). When the receipt system selects individual receipt of the registered mail verification apparatus (212), the registered mail verification apparatus performs a verification method by reflecting the individual receipt.

When the registration number allocation is completed, the provisional receipt data is registered in a distribution integration information apparatus (hereinafter, referred to as PostNet) 100 and provisional receipt data (a verification condition and receipt data) is transmitted to the receipt information linking apparatus 200 of the corresponding receipt division (214).

During this process, a generation operation of verification data for other large quantity of customers is already performed, and immediately when the operation is completed, the generation operation of the verification receipt data is performed by accessing provisional receipt data of the selected customers and when the generation of verification receipt data of the selected customers is completed, the generation operation of the verification receipt data is automatically performed in the order of data received by the receipt information linking apparatus 200.

The person in charge of receipt ascertains whether the generation of the verification receipt data is completed and thereafter, selects and registers individual registered mail verification conditions (211). After registration of a registration request content as the verification reference data is completed, the mail to be verified is provided to the verification apparatus 300 (213).

When the registered mail is provided to the verification apparatus 300, the registered mail verification apparatus 300 performs sorting processing by identifying nonsubmitted data and excessively submitted data based on whether the registered barcode is read, whether the receipt data (address and postal code) is miswritten, and the receipt data, and the verified result value (215).

A result generated during the sorting processing is registered for each verification receipt data field in the registered mail verification apparatus 300, and transmitted (216) and registered (217) as the verification result of the receipt information linking apparatus 200. The registered result is sorted for each acceptance and rejection to generate and register a statement (217) and thereafter, the statement is provided to the receipt apparatus 400 (218).

In the case of the rejected mail, the registered mail verification apparatus 300 transfers the rejected mail to the customer (226), the receipt apparatus 400 reprints a rejection statement including the address and the postal code on the registered barcode label at the time of printing the rejection statement when the postal code in a verification result data statement needs to be corrected (219) and provides the reprinted rejected statement to the customer and the receipt apparatus provides a rejection cause and a registered barcode to the customer (220).

When the customer attaches the reprinted registered barcode label to the mail (221) and provides the mail to the receipt apparatus 400 (222), the registered mail verification apparatus performs the verification operation again and when the rejected mail is normally processed, the error is corrected (223). When the address data is erroneous, a method for reinputting the address data through the receipt apparatus 400 is provided and a method of generating the registered mail table is provided.

A method is provided which complements the verification result of the rejected mail through the receipt system and thereafter, completes the verification, and completes the receipt. A process is included, in which only a part of receipt data corrected during the verification is changed and registered as receipt completed data (224 and 225) to be used in dispatch/arrival sorting, sending information generation, and delivery information generation. The rejection data for the mail of which receipt is completed is notified to the customer 10.

During the above process, the rejected mail is verified in the order of the receipt data file by a method for examining whether the registered label is misattached and when the order is in discord, a process of sorting the corresponding mail as mail misattached with the registered barcode may be included.

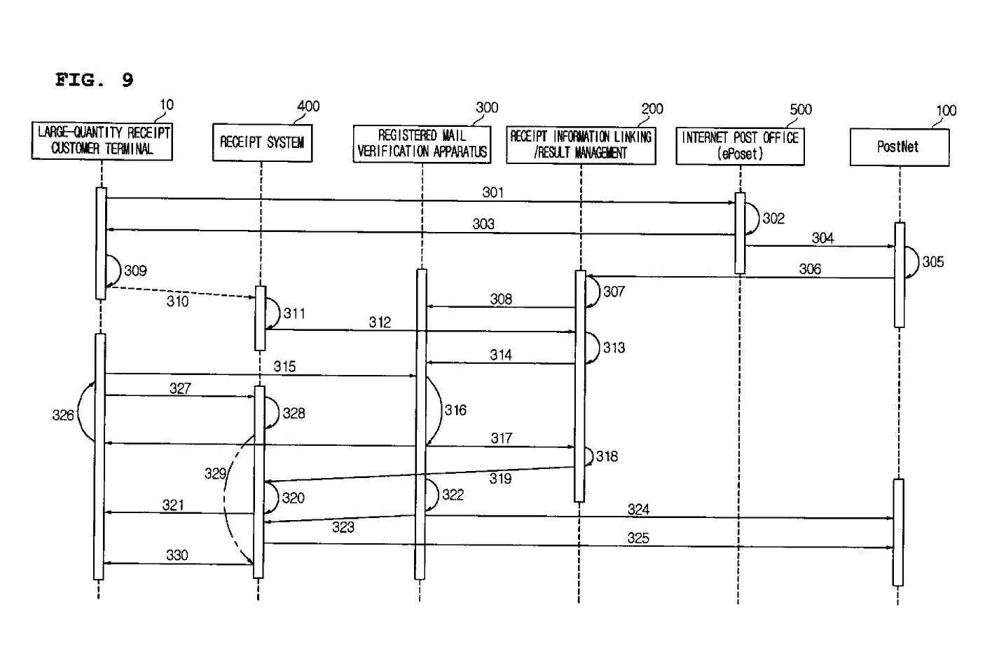

FIG. 9 is a flowchart illustrating a method for verifying receipt of a registered mail according to another exemplary embodiment of the present invention.

Herein, an operating flow based on a difference which occurs when the mail is received in a large quantity from the registered mail received in a small quantity will be described.

When the customer inputs a receipt quantity and a receipt division in the Internet post office apparatus 500 through a large-quantity receipt customer terminal 10 and thereafter, submits a receipt file (301), the Internet post office apparatus 500 registers provisional receipt data (302) and at this time, the Internet post office apparatus 500 grants the registration number to the customer (303) and transmits the receipt file to the PostNet 100 (304).

When the provisional receipt data is registered in the Internet post office apparatus 500 (302), the provisional receipt data is registered in the provisional receipt DB of the distribution integration information system and when the registration is completed, the PostNet 100 transmits the provisional receipt data to the receipt information linking apparatus 200 of the corresponding receipt division (306).

When the receipt information linking apparatus 200 receives the provisional receipt data of the corresponding customer, the receipt information linking apparatus 200 provides a received list and performs a verification data generation operation in accordance with an arrival order (307).

When mail on which the registered barcode is printed (309) and attached is submitted by the customer (310) and weight/quantity examination is completed by the receipt apparatus 400 (311), receipt information is transmitted to the receipt information linking apparatus 200 as the verification condition (312) and a large-quantity registered mail submission condition is identified and registered as the verification reference data (313), and transmitted to the registered mail verification apparatus 300 (314).

The registered mail verification apparatus 300 includes a process in which a presorted, input and registered value is compared with verification reference data when a mail verification content is a presorted bundle and when presorted input and registered value, and the verification reference data do not coincide with each other, the mail may be identified as missorted mail (316). Barcode nonreading and miswriting of the address or the postal code are examined and a verification result for nonsubmitted or excessively submitted quantities is generated.

In the case where another presorted mail which is in discord with the presorted input value 151 is incorrectly provided while the mail is provided (153), when the registered mail verification apparatus 300 detects that presorting and missorting are continued over 10 times at that time (155), in order to verify the presorted mail, the registered mail verification apparatus 300 generates a message to temporarily stop supplying the mail and transfers the generated message to the verification apparatus operation and management system 157, stops an operation of a providing unit to temporarily stop the supplying, and provides a value of the received message to an operation system screen.

When the verification apparatus operation and management system 157 judges the supplying as incorrect supplying in a pause status, the mail conveyance control system 156 allows mail of which the registered barcode is already read to be conveyed to a missorting space and registered mail of which the reading and verification result is not generated to be conveyed to an overflow space or a space designed in a sorting plan, and modifies statistics sorted as the presorting and the missorting to normally processed statistics.

When the verification operation of the presorted mail which is incorrectly provided is completed, a barcode of a registered mail sorted to the missorting space is read to be selected as a correct postal code reference in a missorting statement for easy addition by selecting a corresponding presorting number on a delivery information generation operation screen (FIG. 7) to be added, and an operator directly reads the registered barcode of the missorted registered mail by means of a barcode reader to generate an additionally input (an additional input space of the registration number of FIG. 7) result as delivery information.

When the registered mail is provided to the verification apparatus 300 (315), the registered mail verification apparatus 300 performs sorting processing by identifying nonsubmitted data and excessively submitted quantities based on whether the registered barcode is read, whether the receipt data (address and postal code) is miswritten, and the receipt data, and the verified result value (316).

A result generated during the sorting processing is registered for each verification receipt data field in the registered mail verification apparatus 300, and transmitted (317) and registered (318) as the verification result of the receipt information linking apparatus 200. The registered result is sorted for each acceptance and rejection to generate and register a statement (318) and thereafter, the statement is provided to the receipt apparatus 400 (319).

In the case of the rejected mail, the registered mail verification apparatus 300 transfers the rejected mail to the customer, the receipt apparatus 400 reprints a rejection statement including the address and the postal code on the registered barcode label at the time of printing the rejection statement when only the postal code in a verification result data statement needs to be modified (320) and provides the reprinted rejection statement to the customer and the receipt apparatus provides a rejection cause and a registered barcode to the customer (321).

When the customer attaches the reprinted registered barcode label to the mail (326) and provides the mail to the receipt apparatus 400 (327), the registered mail verification apparatus performs the verification operation again and when the rejected mail is normally processed, the error is corrected (328). When the address data is erroneous, a method for reinputting the address data through the receipt apparatus 400 is provided and a method of generating the registered mail table is provided.

A method is provided which complements the verification result of the rejected mail through the receipt system and thereafter, processes the verification completion, and processes the receipt completion. A process is included, in which only a part of the receipt data modified during the verification is changed and registered as receipt completed data (325) to be used in dispatch/arrival sorting, sending information generation, and delivery information generation. The rejection data for the mail of which receipt is completed is notified to the customer 10 (330). The registered mail verification apparatus generates a label and concludes the presorted mail (320).

When the verification result of the presorted mail is accepted, the presorted mail is sent to the same destination, and as a result, the registered mail verification apparatus 300 generates sending information 322 which is transfer information for delivering the presorted mail to a next distribution point and registers the generated sending information in the PostNet 100 (324).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A registered mail receipt verification system comprising;
a distribution integration information apparatus registering provisional receipt data for customer's receipt;
a receipt information linking apparatus receiving the provisional receipt data from the distribution integration information apparatus and generating verification receipt data for at least one of an address and a postal code; and
a registered mail verification apparatus registering the verification receipt data generated by the receipt information linking apparatus, reading a registered barcode for a provided registered mail, and generating a verification result by comparison with the registered verification receipt data.

2. The system of claim 1, further comprising:
a receipt apparatus receiving registered mail of a predetermined quantity or less from the customer, and assigned with a registration number from the distribution integration information apparatus and providing the assigned registration number to the customer.

3. The system of claim 2, further comprising:
an Internet post office apparatus receiving a receipt file for registered mail which exceeds the predetermined quantity from the customer through a network, registering a provisional receipt file corresponding to the received receipt file, and transmitting a registration number to the customer corresponding to the registered provisional receipt file.

4. The system of claim 3, wherein the distribution integration information apparatus receives the provisional receipt file from the Internet post office apparatus and registers provisional receipt data, and transmits the registered provisional receipt data to the receipt information linking apparatus.

5. The system of claim 3, wherein the receipt information linking apparatus receives and registers the verification result generated by the registered mail verification apparatus and transmits the registered verification result to the receipt apparatus.

6. The system of claim 5, wherein when only modification of the postal code is required based on the verification result, the receipt apparatus reprints a rejection statement so that the address and the postal code are included in the registered barcode label at the time of printing a rejection statement and provides the rejection statement to the customer or labels rejected mail.

7. The system of claim 5, wherein the registered mail verification apparatus compares a presorted input and registered value, and the verification receipt data when a verification content of the registered mail is a presorted bundle and when the presorted input and registered value, and the verification receipt data do not coincide with each other, the registered mail verification apparatus identifies the registered mail as missorted mail.

8. The system of claim 7, wherein the registered mail verification apparatus generates delivery information which is transfer information for shipping the presorted mail to a next distribution point to register the generated delivery information in the distribution integration information apparatus when a verification result of the presorted mail is accepted.

9. A registered mail receipt verification method executed by a registered mail receipt verification system, the method comprising:
registering, by a distribution integration information apparatus, provisional receipt data for customer's receipt;
receiving, by a receipt information linking apparatus, the provisional receipt data and generating verification receipt data for at least one of an address and a postal code; and
registering, by a registered mail verification apparatus, the verification receipt data generated by the receipt information linking apparatus, reading a registered barcode for provided registered mail, and generating a verification result by comparison with the registered verification receipt data.

10. The method of claim 9, further comprising:
receiving, by a receipt apparatus, registered mail of a predetermined quantity or less from the customer, and being assigned with a registration number from the distribution integration information apparatus and providing the assigned registration number to the customer.

11. The method of claim 10, further comprising:
receiving, by an Internet post office apparatus, a receipt file for registered mail which exceeds the predetermined quantity from the customer through a network, registering a provisional receipt file corresponding to the received receipt file, and transmitting a registration number to the customer corresponding to the registered provisional receipt file.

12. The method of claim 11, further comprising:
receiving, by the distribution integration information apparatus, the provisional receipt file from the Internet post office apparatus and registering provisional receipt data, and transmitting the registered provisional receipt data to the receipt information linking apparatus.

13. The method of claim 11, further comprising:
receiving and registering, by the receipt information linking apparatus, the verification result generated by the registered mail verification apparatus and transmitting the registered verification result to the receipt apparatus.

14. The method of claim 13, further comprising:
when only modification of the postal code is required based on the verification result, reprinting, by the receipt apparatus, a rejection statement so that the address and the postal code are included in the registered barcode label at the time of printing a rejection statement and providing the rejection statement to the customer or labeling rejected mail.

15. The method of claim 13, wherein the registered mail verification apparatus compares a presorted input and registered value, and the verification receipt data when a verification content of the registered mail is a presorted bundle and when the presorted input and registered value, and the verification receipt data do not coincide with each other, the registered mail verification apparatus identifies the registered mail as missorted mail.

16. The method of claim 15, wherein the registered mail verification apparatus generates delivery information which is transfer information for shipping the presorted mail to a next distribution point to register the generated delivery information in the distribution integration information apparatus when a verification result of the presorted mail is accepted.

17. The method of claim 15, wherein the registered mail verification apparatus performs:
temporarily stopping the verification apparatus when presorted mail and missorted mail are continuously generated in a predetermined reference quantity or more during verifying the presorted mail;
conveying the presorted and missorted mail which are temporarily stopped in the case of incorrectly provided presorted mail and mail of which a verification operation is not completed to a designated sorting space, and correcting verification statistics of missorted mail which is continuously generated;
storing a registration number of the incorrectly provided presorted mail in a temporary buffer; and
generating delivery information including a directly input result value by reading a presorting number or a registered barcode of the selected presorted or missorted mail.
